(19) United States
(12) Patent Application Publication
(10) Pub. No.: US 2016/0055314 A1
(43) Pub. Date: Feb. 25, 2016

(54) METHOD, SYSTEM, AND APPARATUS FOR ELECTRONIC PRIOR AUTHORIZATION ACCELERATOR

(71) Applicant: Surescripts LLC, Arlington, VA (US)

(72) Inventors: Todd M. Anderson, Minneapolis, MN (US); Bradley C. Simons, Rosemount, MN (US); Keith E. Willard, Saint Paul, MN (US); Mark A. Gingrich, Minneapolis, MN (US); Ryan D. Hess, McLean, VA (US)

(21) Appl. No.: 14/559,620

(22) Filed: Dec. 3, 2014

Related U.S. Application Data
(60) Provisional application No. 62/039,336, filed on Aug. 19, 2014.

(51) Int. Cl. G06F 19/00; H04L 12/24; G06F 3/0484; G06F 17/30

(52) U.S. Cl. CPC G06F 19/3456; G06F 19/328; G06F 19/363; G06F 17/3092; H04L 41/0266; G06F 3/0484

(57) ABSTRACT

Methods, systems, and apparatuses are described for facilitating the delivery of an electronic prior authorization (ePA). Unique systems for facilitating the delivery of an ePA by an ePA provider system to an ePA requestor system and for modeling the state of an ePA request/response process are provided. A user interface (UI) generation component for dynamically generating a UI for presentation to a user is also provided. Methods corresponding to the functions performed by the systems and apparatuses are also provided.

### CROSS-REFERENCE TO RELATED APPLICATIONS

This application claims the benefit of U.S. Provisional Patent Application No. 62/039,336, filed on Aug. 19, 2014, the entirety of which is incorporated by reference herein.

### BACKGROUND

1. Technical Field

The present invention relates to methods, systems, and apparatuses for an electronic prior authorization (ePA) accelerator.

2. Background Art

The National Council for Prescription Drug Programs (NCPDP) is an American National Standards Institute accredited, standards development organization that promulgates standards for healthcare solutions. The NCPDP standard for ePA is a standard for providing the electronic adjudication of a benefit that needs authorization from a provider/payer. This standard is extensible markup language (XML) based, provides for XML messages to be transmitted between a requester/prescriber and a provider/payer, and is required for ePA. However, the standard is complex and each of the vast number of electronic medical record (EMR) and electronic healthcare record (EHR) system vendors in the healthcare marketplace must comply with this XML communication standard when performing a transaction for an ePA using their respective systems.

### BRIEF SUMMARY

Methods, systems, and apparatuses are described for an electronic prior authorization (ePA) accelerator, substantially as shown in and/or described herein in connection with at least one of the figures, as set forth more completely in the claims.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of an ePA accelerator implementation, according to an exemplary embodiment.

FIG. 2 is a request/response diagram of a basic transaction for requesting and providing a prior authorization (PA).

FIG. 3 is a portion of XML code of an example message in accordance with the NCPDP XML messaging standard.

FIG. 4 shows a portion of a user interface that may be presented to an ePA requestor, according to an exemplary embodiment.

FIG. 5 shows a block diagram of a portion of an example ePA accelerator system, according to an exemplary embodiment.

FIG. 6 shows an ePA accelerator class diagram, according to an exemplary embodiment.

FIG. 7 is a block diagram of a workflow engine integrated with an ePA accelerator system, according to an exemplary embodiment.

FIG. 8 is a block diagram of a model layout which utilizes an RDF (Resource Description Framework) model configured to drive the behavior of the workflow engine of FIG. 7, according to an exemplary embodiment.

FIG. 9 shows a transaction flow for facilitating the provision of an ePA by an ePA provider system to an ePA requestor system, according to an exemplary embodiment.

FIGS. 10-14 are flowcharts of methods for facilitating the delivery of electronic prior authorizations (ePAs), according to exemplary embodiments.

FIG. 15 is a block diagram of a computer system, according to an exemplary embodiment.

Embodiments will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION

### Introduction

The present specification discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

Numerous exemplary embodiments are described as follows. It is noted that any section/subsection headings provided herein are not intended to be limiting. Embodiments are described throughout this document, and any type of embodiment may be included under any section/subsection. Furthermore, disclosed embodiments may be combined with each other in any manner.

### Example Embodiments

In today's healthcare marketplace, doctors may prescribe medications to patients that require prior authorization (PA). For instance, before prescribing or providing expensive prescription medications and/or medications for certain conditions, a doctor or pharmacist may be required to obtain a prior approval of an insurance carrier of the patient (e.g., from a pharmacy benefits management (PBM) system utilized by the insurance carrier) to ensure that the medication prescribed will be paid for by the insurance carrier. Provisioning PA electronically (i.e., electronic prior authorization (ePA)) is more efficient than traditional methods of PA. However, the NCPDP standard for ePA requires that messages for adjudicating an ePA be transmitted in strict accordance with a promulgated XML format.

In embodiments, a unique ePA accelerator is described that utilizes a user interface (UI) service component and a UI generation component that allows ePA requestors using ePA requestor systems (e.g., systems provided by electronic medical record (EMR) and electronic health record (EHR) system vendors) to seamlessly and efficiently adhere to the NCPDP XML standard for ePA when communicating electronically with ePA provider systems (e.g., PBM systems) utilized by ePA providers. The embodiments described herein provide for a hub model implementation of a system for facilitating the provision of an ePA by an ePA provider (e.g., a payer, insurance company, or insurance company representative) to an ePA requestor (e.g., a doctor, a pharmacist, or a prescriber). Additionally, embodiments allow for modeling, tracking, and updating of the state of ePA adjudications and the reporting thereof to ePA providers and ePA requestors.

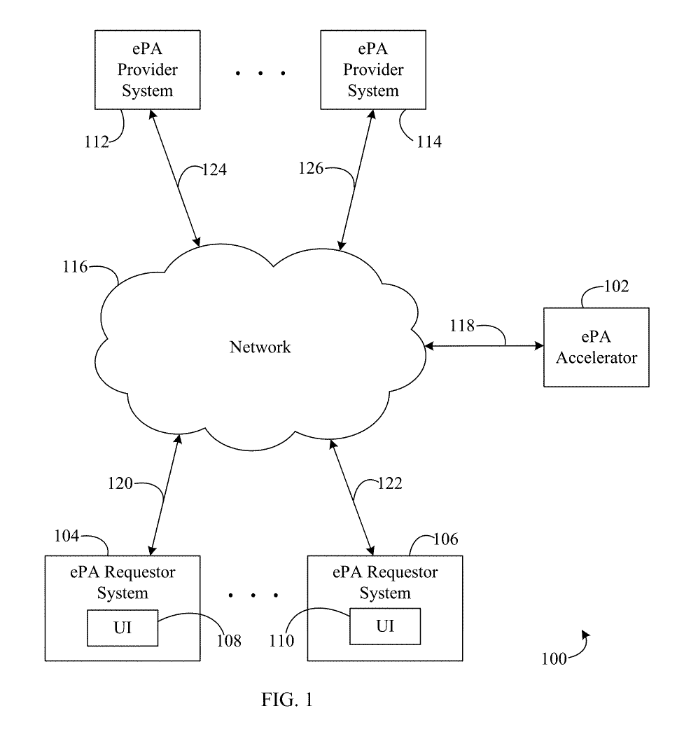

For example, FIG. 1 shows an ePA accelerator implementation 100, according to an example embodiment. As shown in FIG. 1, ePA accelerator implementation 100 includes an ePA accelerator 102 that may be connected to a network 116 via a network connection 118. ePA accelerator implementation 100 also includes a plurality of ePA requestor systems (104, 106) that may each be connected to network 116 via network connections 120 and 122 respectively, and a plurality of ePA provider systems (112, 114) that may each be connected to network 116 via network connections 124 and 126 respectively. While two ePA requestor systems and ePA provider systems are shown for illustration, fewer or more of either the ePA requestor systems and/or the ePA provider systems may be included in embodiments. ePA requestor system 104 and ePA requestor system 106, as shown, each include a UI. For example, ePA requestor system 104 includes a UI 108, and ePA requestor system 106 includes a UI 110. In embodiments, ePA accelerator 102 acts as a hub for communications between the plurality of ePA requestor systems (104, 106) and the plurality of ePA provider systems (112, 114), e.g., during ePA request/response processes, as described in further detail herein.

In embodiments, ePA accelerator 102 is configured to receive messages from ePA requestor systems 104, 106 intended for ePA provider systems 112, 114, and messages from ePA provider systems 112, 114 intended for ePA requestor systems 104, 106. In some embodiments, messages received from ePA provider systems 112, 114 may be formatted according to the NCPDP XML standard, and ePA accelerator 102 is configured to provide information from the received XML messages to ePA requestor systems 104, 106 in a non-XML format such as JavaScript, a version of a JavaScript language such as JavaScript Object Notation (JSON), a HyperText Markup Language (HTML), and/or the like. Similarly, in embodiments messages received from ePA requestor systems 104, 106 may be in non-XML formats, and ePA accelerator 102 is configured to provide information from the received non-XML messages to ePA provider systems 112, 114 in accordance with the NCPDP XML standard. Accordingly, ePA accelerator 102 is configured to operate in a hub model in which all or a portion of communications between ePA requestor systems and ePA provider systems go through ePA accelerator 102. ePA accelerator 102 is configured to provide a dynamically generated UI to one or more client computers of ePA requestor systems 104, 106, as described further herein. ePA accelerator 102 is also configured to track and/or model ePA request/response processes and/or communications between ePA requestor systems 104, 106 and ePA provider systems 112, 114. ePA accelerator 102 may be implemented as a system, as one or more computers, e.g., a server computer(s), and/or as distributed computing resources, according to embodiments.

In embodiments, ePA requestor systems 104, 106 may be an application(s), a computer(s) and/or a system(s), or any combination thereof, provided by EMR/EHR system vendors to be utilized by ePA requestors. For the purposes of this disclosure, a computer of an ePA requestor that is used by the ePA requestor to access an ePA requestor system may be considered a computer of the ePA requestor system. ePA requestor systems 104, 106 may be related or independent entities. An ePA requestor, using an ePA requestor system (e.g., 104, 106) may request initiation of an ePA process from an ePA provider that uses an ePA provider system (e.g., 112, 114) via ePA accelerator 102. An ePA requestor system may provide information, via ePA accelerator 102, to an ePA provider system in an ePA request responsive to a question set provided from the ePA provider system for obtaining an ePA. ePA requestor systems 104, 106 may utilize the dynamically generated UI provided from ePA accelerator 102 to facilitate ePA processes as described herein, according to embodiments.

In embodiments, ePA providers may be payers, insurance companies, and/or their representatives, that use pharmacy benefits management (PBM) systems associated therewith. ePA providers may be related or independent entities. ePA providers may use ePA provider systems such as ePA provider systems 112, 114 to provide questions or question sets in messages sent to ePA requestor systems such as ePA requestor systems 104, 106 used by ePA requestors via ePA accelerator 102. Responses to ePA requests that indicate acceptance, denial, etc., of the ePA request may also be sent using ePA provider systems 112, 114. In embodiments, messages sent by ePA provider systems 112, 114 may be sent in accordance with the NCPDP XML standard. In other words, the standard requires that messages have certain content that is formatted in a certain manner, and messages sent by ePA provider systems may include such content in such a format. It should be noted that messages from independent ePA provider systems to ePA requestor systems need not include the same questions (either in form and/or content) for similar or identical ePA requests while still conforming to the NCPDP XML standard.

In embodiments, network 116 may be the Internet and/or any other network over which ePA request/response processes and/or communications between ePA requestor systems 104, 106 and ePA provider systems 112, 114 may be transmitted. In embodiments, network 116 may comprise one or more individual networks. Network connections (e.g., 118, 120, 122, 124, and/or 126) may each be either wired connections or wireless connections, or may be a combination of wired and wireless connections.

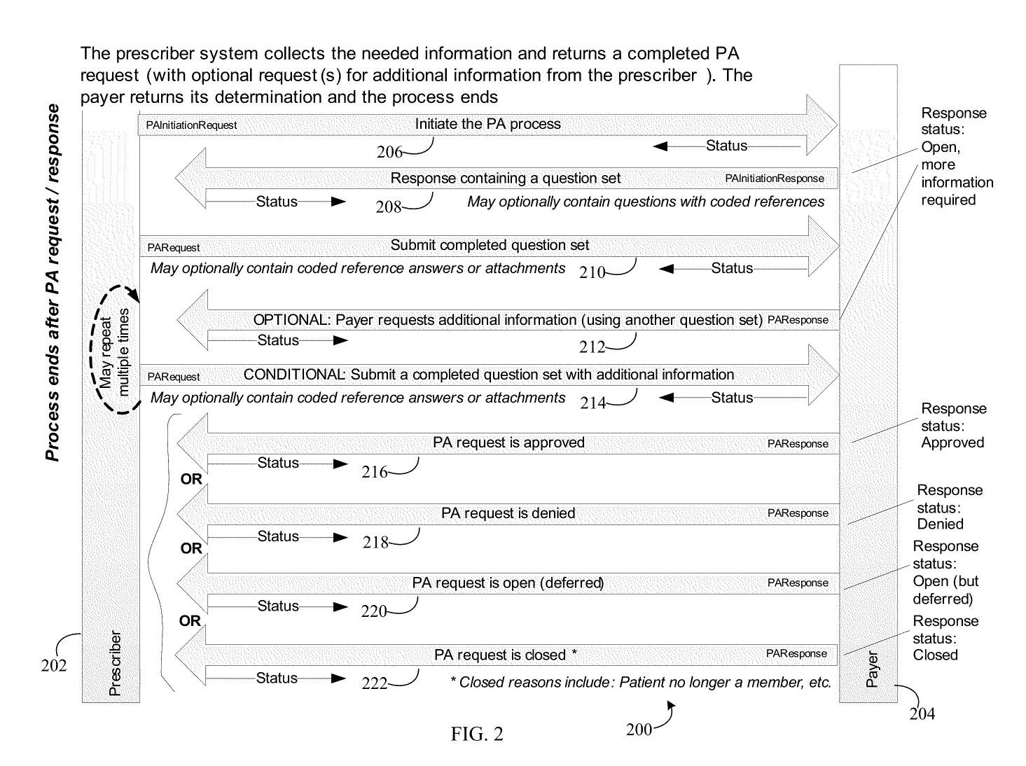

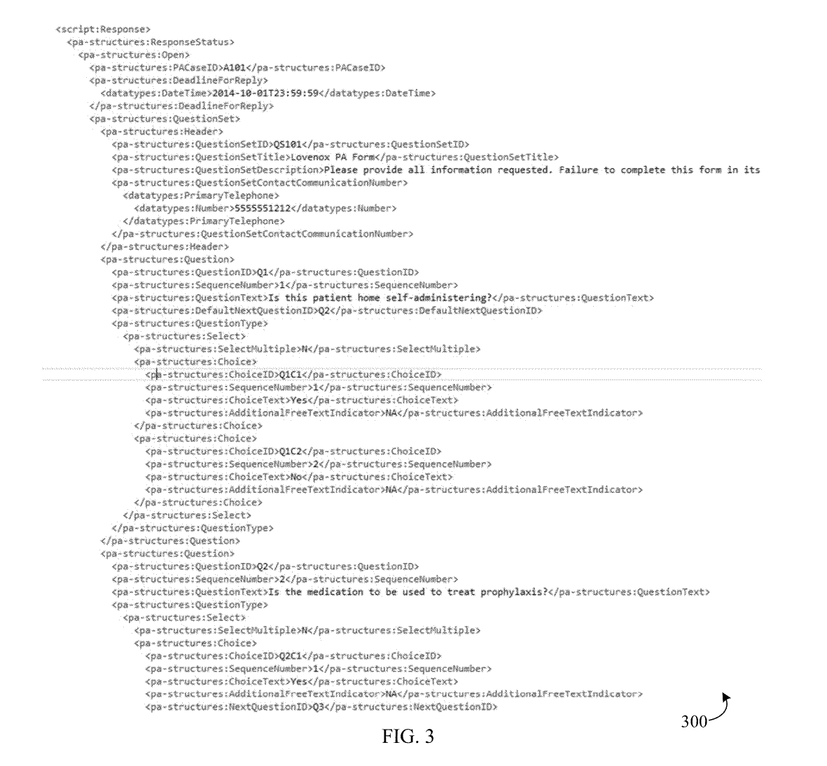

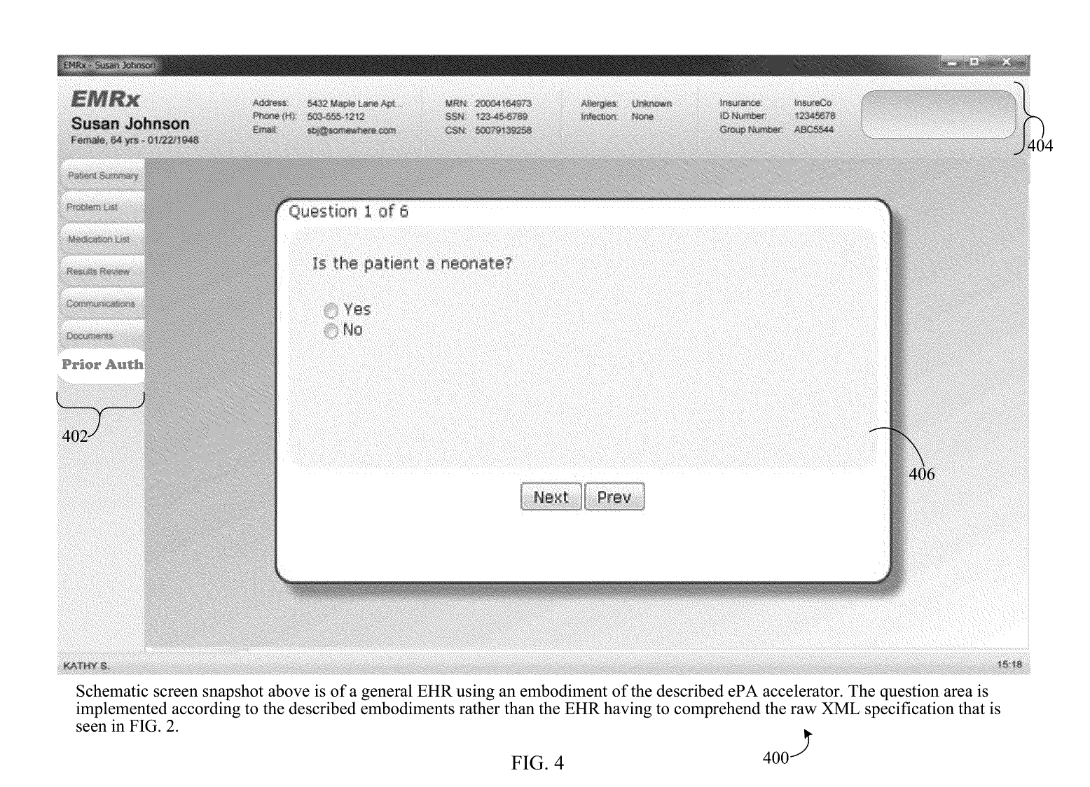

FIG. 2 shows an exemplary request/response diagram of a basic prior authorization (PA) transaction 200 for providing a PA from a PA provider 204 (e.g., a payer) to a PA requestor 202 (e.g., a prescriber). For instance, the providing of the PA may be carried out via telephone and/or facsimile correspondence between PA provider 204 and PA requestor 202. In the context of ePA in accordance with embodiments described herein, ePA transactions may be carried out by sending XML messages that accord with the NCPDP XML messaging standard over a network such as the Internet between ePA providers using ePA provider systems and ePA requestors using ePA requestor systems.

As shown in FIG. 2, PA requestor 202 may submit an initiation request to PA provider 204 to initiate the PA process at 206. In response, PA provider 204 responds by providing a question set to PA requestor 202 as a PA initiation response at 208. The question set may include questions such as, but not limited to, information requests regarding a patient's age, health state, recent changes in health state, current medications, past or recent medical procedures, and/or the like relating to the patient's medical/health history and/or status. Upon receipt of the question set at 208, PA requestor 202 answers the questions and provides responses (that may include additional information and attachments) as a PA request to PA provider 204 at 210. PA provider 204 may then optionally request additional information from PA requestor 202 in the form of more questions in a PA response at 212. If additional questions are sent to PA requestor 202, PA requestor 202 then provides answers to these additional questions in another PA Request at 214. Several iterations of additional questions and responses, as described above with respect to 212 and 214, may take place. PA provider 204 may, when sufficient information is deemed to have been attained, provide one of a number of PA responses to PA requestor 202. For example, in a PA response, PA provider 204 may approve the PA request at 216, deny the PA request at 218, defer the PA request and leave it in an “open” state at 220, and/or “close” the PA request at 222.

Again referring to the NCPDP XML messaging standard, FIG. 3 shows a portion of XML code of an example message 300 in accordance with the standard. As can be seen, the XML code of such messages contains numerous XML fields and tags as required by the NCPDP. The complexity of XML message 300, of which only a portion is shown in FIG. 3, is required for completeness of XML messages in order to adhere to the NCPDP XML messaging standard, but such complexity produces difficulties for receiving and deciphering messages, as well as composing responses to messages that adhere to the standard. In the current healthcare marketplace, there exist hundreds of EMR and EHR system vendors having respective EMR/EHR systems that must conform to the NCPDP XML messaging standard when facilitating the delivery of an ePA which is a very complex task.

The embodiments described herein allow for different ePA requestors to communicate with different ePA providers without having to handle raw XML messages, as per the NCPDP XML standard, while still conforming to the message standard. In other words, when an ePA requestor uses an ePA requestor system, such as an EMR/EHR system provided by an EMR/EHR system vendor, to communicate with an ePA provider through its associated ePA provider system, the ePA requestor and the ePA requestor system are not required to be able to handle NCPDP XML standard messages. Thus, the techniques and embodiments described herein provide for improvements in processes for obtaining an ePA.

For instance, methods, systems, and apparatuses are provided for obtaining an ePA and for state tracking, in accordance with the inventive techniques. In an example aspect, a computer-readable storage medium having computer program instructions encoded thereon that, when executed by a processing device, perform a method for facilitating the delivery of an electronic prior authorization (ePA) by an ePA provider system to an ePA requestor system. The method includes receiving over a computer network a representation of a first XML message relating to an ePA request from the ePA requestor system and dynamically generating a user interface (UI) based on at least a portion of the representation. The method also includes presenting the UI to a user of the ePA requestor system, and dynamically generating a user input message based on information received from the user via the UI.

In another example aspect, a system is disclosed for modeling the state of an ePA request/response process. The system includes a storage component configured to persistently store a framework model of the ePA request/response process and to persistently store one or more state representations, and a state modeling component. The state modeling component is configured to track a current state of the ePA request/response process according to the model. The state modeling component is also configured to identify a change from the current state of the ePA request/response process to a new state of the ePA request/response process, and to generate a state representation based on the new state of the ePA request/response process. The state modeling component is further configured to provide the state representation to the at least one storage component for storage thereby.

In yet another example aspect, a method performed by one or more servers for facilitating the delivery of at least one electronic prior authorization (ePA) by an ePA provider system to an ePA requestor system is provided. The method includes providing computer-executable instructions to a client computer of the ePA requestor system over a network, the instructions, when executed by the client computer, performing a client-side method comprising: dynamically generating a user interface (UI) based on at least a portion of a representation of a first XML message relating to at least one ePA request from the ePA requestor system that is received over the network. The method also includes receiving the first XML message from the ePA provider system over the network, the first XML message relating to the at least one ePA request from the ePA requestor system, dynamically generating the representation, and providing the representation to the client computer. The method further includes generating, subsequent to providing the representation, a second XML message based on information received from the client computer, the information being obtained by the client computer via the UI, and transmitting the second XML message to the ePA provider system over the network.

It is contemplated that embodiments described herein with respect to an ePA accelerator are not so limited, and that other types and aspects of ePA, as well as prior authorizations generally, may be utilized in such embodiments, as would be understood by a person of skill in the relevant art(s) having the benefit of this disclosure.

Various example embodiments are described in the following subsections. In particular, example UI embodiments are described, followed by example ePA accelerator embodiments. Example operational embodiments are subsequently described. Next, further example embodiments and advantages are described. Finally, some concluding remarks are provided.

### Example User Interface Embodiments

In accordance with the inventive embodiments described herein, FIG. 4 shows an example user interface (UI) 400 that may execute on ePA requestor systems such as ePA requestor systems 104, 106 of FIG. 1. UI 400 is a UI of which a portion may be an embedded component provided to an ePA requestor system by interacting with an embodiment of the described ePA accelerator (e.g., ePA accelerator 102 of FIG. 1). In embodiments, UI 400 may be a further embodiment of UIs 108 and/or 110 of FIG. 1, and the embedded component may be provided from ePA accelerator 102 to ePA requestor systems 104, 106 for embedding over network 116.

UI 400 may include a patient identification information section 404 for displaying information about a patient (e.g., a patient for which an ePA process regarding a prescription will take place), and may include one or more selection portions 402 from which a user may be able to select UI displays with information and functionality associated with more detailed information about the patient. For instance, selection portions 402 may include selectable options for, without limitation, the following: a patient summary, a problem list, a medication list, a results review, communications, documents, and/or prior authorization. In embodiments for ePA, selecting prior authorization may provide or display to a user of the UI a question area 406.

Question area 406 may be implemented according to described embodiments, thereby enabling the ePA requestor system to provide a means for carrying out the ePA request/response protocol without having to generate or interpret the raw XML messages required by the NCPDP XML messaging standard, as shown in FIG. 3. In other words, according to described embodiments, systems, methods, and apparatuses allow a user such as an ePA requestor to easily answer question sets received in an ePA provider system message (according to the NCPDP XML standard) by providing a UI based at least in part on the message, wherein question area 406 of UI 400 may easily be embedded within an existing ePA requestor system (e.g., in a browser as described herein). Likewise, according to the described embodiments, systems, methods, and apparatuses allow the user such as an ePA requestor to send a response message, using an ePA requestor system, that contains the answers to a question set according to the standard without the user having to format the response message per the standard. The inventive embodiments described herein provide a seamless implementation that can easily be embedded in existing ePA requestor systems and that enables users thereof to communicate according to the standard without requiring any logic within the ePA requestor system that is capable of generating or processing the XML messages. In embodiments, logic and/or instructions associated with embedded portions UI 400 may dynamically generate subsequent UI displays for at least question area 406. Such dynamic generation may be based, at least in part, on questions presented in question area 406 and answers provided by a user to the questions.

It should be noted that references to a “UI” or a “portion of a UI” may be used interchangeably throughout this disclosure unless explicitly stated otherwise. For instance, if a component of ePA accelerator 102 dynamically generates a UI, it is also intended that this component may dynamically generate a portion of a UI (e.g., question area 406) according to embodiments.

### Example ePA Accelerator Embodiments

The embodiments described herein may be configured in various ways as will become apparent to a person of skill in the relevant art(s) having the benefit of this disclosure.

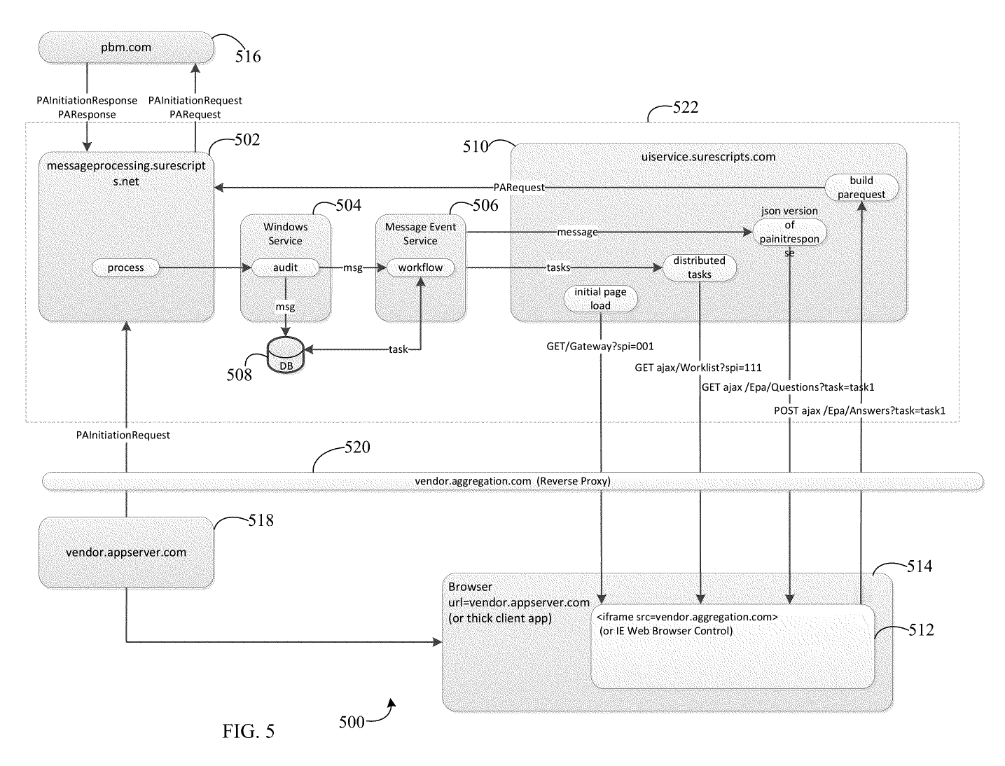

For instance, FIG. 5 shows an exemplary block diagram of ePA accelerator implementation 500 as described herein. In embodiments, ePA accelerator 102 of FIG. 1 may be comprised of one or more of ePA accelerator components 522 shown in FIG. 5. For example, FIG. 5 shows a message processing component 502, a user interface service component 510, a database (DB) 508, a windows service component 504, and a message event service component 506 as part of the exemplary ePA accelerator components 522. In some embodiments, a UI generation component 512 may be included with and/or stored in exemplary ePA accelerator components 522, and/or may be embedded in a browser 514 of a computer of an ePA requestor system. ePA accelerator components 522 may be implemented as a hub model that communicates with one or more of ePA provider systems 112, 114, e.g., PBM systems 516 (one shown), and one or more of ePA requestor systems 104, 106 via browser 514 (one shown). In embodiments, the aforementioned hub model enables an ePA requestor system to interact with a wide variety of PBM systems 516 through browser 514 to carry out the ePA request/response protocol regardless of how each of those PBM systems 516 have implemented the ePA process based on the NCPDP XML standard. For instance, PBM systems may implement question sets differently, even for the same prescribed medication for which an ePA may be requested, and the embodiments described herein allow an ePA requestor system to interact seamlessly with each PBM system in accordance with the NCPDP XML standard.

Components and entities outside of ePA accelerator components 522 are also shown in ePA accelerator implementation 500 of FIG. 5. For example, browser 514 may execute on a computer of ePA requestor systems 104, 106. ePA requestor systems 104, 106 may include an application server 518 operated by an EMR/EHR system vendor that contains, without limitation, patient information, ePA requestor information, and/or drug information. A reverse proxy server 520 may also be present in embodiments, as would be understood by a person of skill in the relevant art(s) having the benefit of this disclosure, and may also be operated by an EMR/EHR system vendor. As shown, PBM system 516 may be an implementation of ePA provider systems 112, 114, as described herein.

In embodiments, message processing component 502 is configured to receive and process incoming messages from PBM system 516 being transmitted to an ePA requestor system via browser 514, as well as transmitted messages from an ePA requestor system via browser 514 to PBM system 516. For example, message processing component 502 is configured to receive ePA initiation requests and ePA requests from ePA requestor systems. ePA initiation requests may be received via application server 518 (which may allow for the inclusion of data stored therein in an ePA initiation request). Message processing component 502 is configured to transmit the ePA initiation requests and XML versions of the ePA requests to PBM system 516. Similarly, message processing component 502 is configured to receive ePA initiation responses and ePA responses from PBM system 516. Message processing component 502 is configured to process/parse each of the received responses and requests, and provide processed/parsed message information to window service component 504 and/or message event service component 506.

In embodiments, windows service component 504 is configured to receive processed/parsed message outputs from message processing component 502. The processed/parsed message outputs may be audited and have portions thereof placed in an audit table from which tasks and additional messages may be generated and from which tasks and messages may be stored in DB 508.

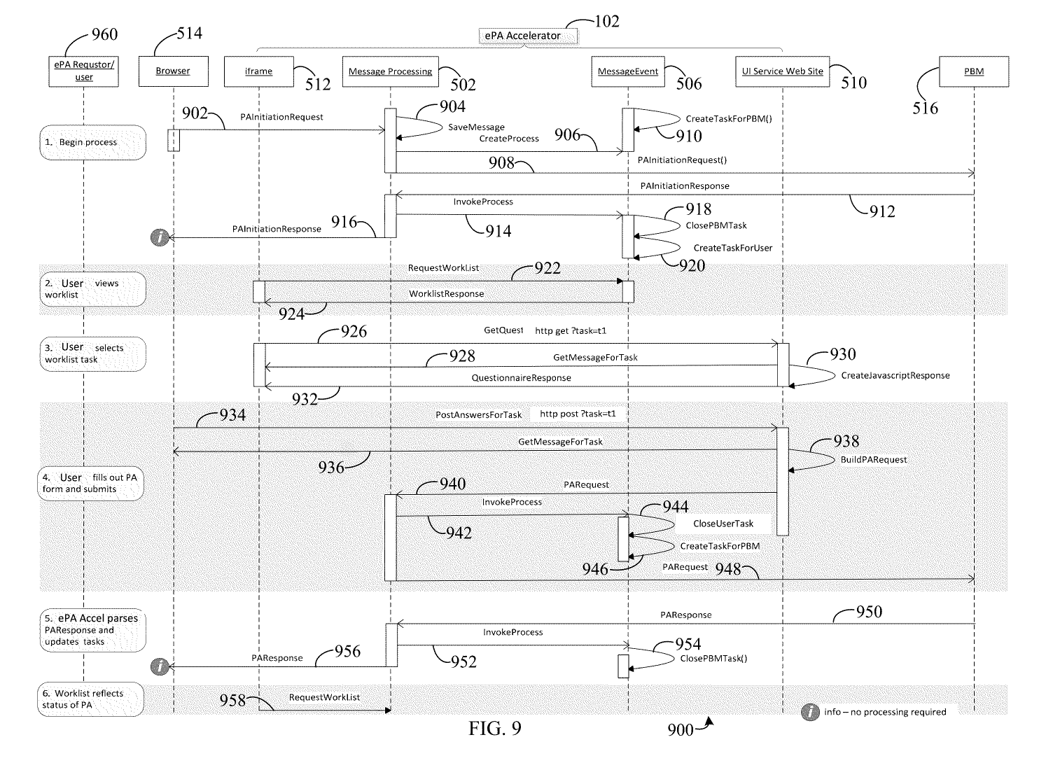

Additionally, windows service component 504 may be configured to provide various services to ePA requestor systems and browser 514, and to PBM systems 516. For instance, in embodiments, windows service component 504 may operate as an audit component configured to audit the state of the ePA adjudication. For example, as shown in FIG. 9 and described below, an ePA adjudication may be a complex, involved transaction with numerous messages (e.g., requests and responses) that may be handled by the ePA accelerator components 522 described herein. At various stages of the adjudication, windows service component 504 acting as an audit component may track the progress (i.e., state) through the adjudication by determining the current state thereof and storing the state in DB 508. In embodiments, a change in state may prompt windows service component 504, as an audit component, to determine and update the current state. The state and its associated tracking may be modeled using a framework such as RDF, although any applicable frameworks are contemplated for use in embodiments.

Once stored in DB 508, state information for a given ePA adjudication may be provided to ePA requestor systems from UI service component 510 via browser 514 and to PBM systems 516 by the embodiments of ePA accelerator components 522 via message processing component 502.

In embodiments, message event service component 506 is configured to generate a workflow, as described herein, based on the processed message. For example, a question set in a NCPDP XML message from PBM system 516 may be represented as workflow tasks and messages created by message event service component 506. Such tasks and messages may be provided to UI service component 510 to generate representations of NCPDP XML messages to be used for dynamically creating a UI for presentation to the user, as described below. In embodiments, the workflow tasks and messages may be stored along with state information in DB 508.

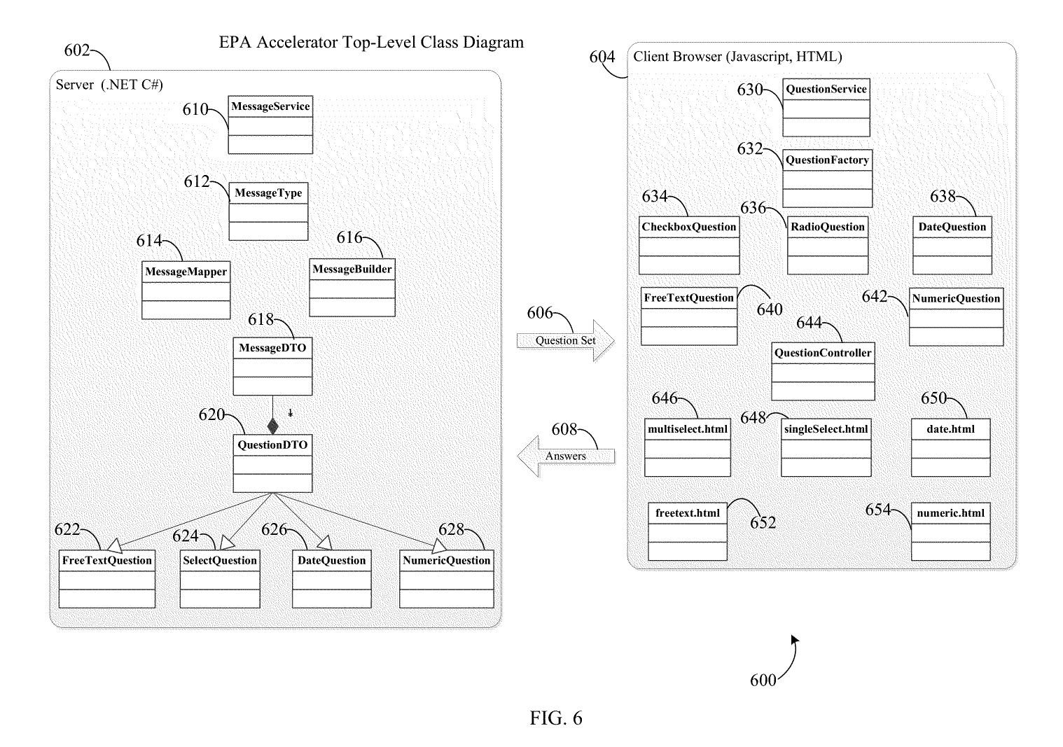

In embodiments, UI service component 510 is configured to receive the tasks and messages from message event service component 506 and generate an initial load page for the UI to be presented by UI generation component 512. UI service component 510 is also configured to generate a list of distributed tasks that may be provided to UI generation component 512 for display via UI generation component 512 in browser 514 upon request by ePA requestors using ePA requestor systems 104, 106. UI service component 510 is further configured to generate non-XML versions (JavaScript, JSON, HTML, and/or the like) of questions, e.g., provided in an ePA initialization response or ePA response, to be utilized by UI generation component 512. UI service component 510 may generate the non-XML question representations by translating information from the received message into classes and objects that may be utilized by UI generation component 512 according to classes and objects of class diagram 600 of FIG. 6, described below.

UI service component 510 is also configured to receive answers to questions and information from ePA requestor systems 104, 106 via UI generation component 512 and generate a corresponding NCPDP XML message to be provided to PBM system 516.

In embodiments, UI generation component 512 is configured to display a task list and allow ePA requestors (i.e., users) using ePA requestor systems 104, 106 to select a task associated with answering the questions provided from ePA provider systems 112, 114. UI generation component 512 is also configured to dynamically generate a UI for presentation to a user via browser 514 responsive to the selected task. In some embodiments, UI generation component 512 may be embedded within browser 514 after being provided to an ePA requestor system, and browser 514 may be a further embodiment of UI 400 of FIG. 4. In embodiments, UI generation component 512 is configured to dynamically generate the UI based on the tasks and messages from message event service 506 as modified by UI service component 510. Further details of the dynamic UI generation are described elsewhere herein. The generated UI may be presented to a user by UI generation component 512 in browser 514 of an ePA requestor system as shown. In embodiments, UI generation component 512 is configured to dynamically generate one or more portions of the UI based on information and/or answers provided by the ePA requestor, using the ePA requestor system, to the question set from the ePA provider system.

The provisioning functionality of UI service component 510 described above may be carried out according to various known protocols and standards/specifications such as, but not limited to, HTML and HTML calls, asynchronous JavaScript and XML (AJAX), JavaScript, etc., and not only those protocols and standards/specifications shown or described are contemplated.

Additional details regarding the operational flow of ePA accelerator components 522 are described in below with respect to FIG. 9.

FIG. 6 shows an exemplary, non-exhaustive, ePA accelerator class diagram 600, according to embodiments. Generally, ePA accelerator 102 (i.e., the server side) intercepts NCPDP XML standard messages sent from an ePA provider system, translates the message into a format (JavaScript, JSON, HTML, and/or the like) suitable for utilization by a client computer of an ePA requestor system (i.e., the client side), collects answers to questions from the XML message in the client format from the client, builds an NCPDP XML standard message from the resulting answers, and forwards the built message to the ePA provider system. The client-side application may include classes and objects related to, e.g., JavaScript, HTML, or similar content served from ePA accelerator 102 and may be utilized by UI generation component 512 embedded in an application at the client computer, as described herein. In embodiments, UI generation component 512 may receive question sets in a JSON format from UI service component 510.

A set of server classes in a server class structure 602 residing in ePA accelerator 102 (e.g., in UI service component 510), and a set of client classes in a client class structure 604 residing in UI generation component 512 embedded in browser 514 of ePA requestor systems 104, 106 are shown. One or more of ePA accelerator components 522 of FIG. 5 may perform one or more of their respective functions based on the exemplary class diagram 600 of FIG. 6. Server class structure 602 and client class structure 604 allow for ePA accelerator 102 embodiments to receive and process NCPDP XML message from ePA provider systems 112, 114 of FIG. 1, and generate corresponding UI classes for presentation of UI 108, 110 to an ePA requestor using ePA requestor system 104 or 106 of FIG. 1. For instance, an XML message may be received and parsed by ePA accelerator 102 (e.g., by message processing component 502). Server class structure 602 may be used by UI service component 510 to generate and provide a question set 606, based on the parsed message, in a non-XML format such as JavaScript, JSON, HTML, and/or the like, to be utilized by client class structure 604 to dynamically generate a UI or a portion thereof. Question set 606 may be referred to as a representation of the questions from a received XML message. User inputs and answers 608 to questions are collected according to client class structure 604 and are provided in the non-XML format to ePA accelerator 102 (e.g., by UI service component 510) where an XML message is generated for transmission to ePA provider systems 112, 114.

Server class structure 602 may include a message service class 610, a message type class 612, a message mapper class 614, a message builder class 616, a message data transfer object (DTO) class 618, a question DTO class 620, a free text question class 622, a select question class 624, a date question class 626, and a numeric question class 628. Client class structure 604 may include a question service class 630, a question factory class 632, a checkbox question class 634, a radio question class 636, a date question class 638, a free text question class 640, a numeric question class 642, a question controller class 644, a multi-select HTML class 646, a single-select HTML class 648, a date HTML class 650, a free text HTML class 652, and a numeric HTML class 654. Server classes will now be described in further detail.

Message service class 610 retrieves a received XML message from a database, e.g., DB 508.

Message type class 612 is a de-serializing class that takes parsed, de-serialized XML message strings and converts these strings into a server-specific object type, e.g., a Microsoft® .NET C# object.

Message mapper class 614 translates de-serialized XML objects into DTO objects (e.g., maps the XML version into a JSON version of the object).

Message builder class 616 converts objects that represent information and/or answers to the questions that are received from ePA requestor systems 104, 106 via UI generation component 512 (e.g., in JSON format) into de-serialized XML objects.

Message DTO class 618 supports message mapper class 614 by translating information from the XML message, e.g., patient information, drug information, etc., into a format that may be utilized by UI generation component 512 (e.g., JSON format).

Question DTO class 620 supports message mapper class 614 by translating questions from the XML message, into a format that may be utilized by UI generation component 512 (e.g., JSON format).

Free text question class 622 supports message mapper class 614 and question DTO class 620 by translating free text questions from the XML message into format that may be utilized by UI generation component 512 (e.g., JSON format).

Select question class 624 supports message mapper class 614 and question DTO class 620 by translating selectable answer questions from the XML message into a format that may be utilized by UI generation component 512 (e.g., JSON format).

Date question class 626 supports message mapper class 614 and question DTO class 620 by translating date-related questions from the XML message into format a that may be utilized by UI generation component 512 (e.g., JSON format).

Numeric question class 628 supports message mapper class 614 and question DTO class 620 by translating numeric answer questions from the XML message into a format that may be utilized by UI generation component 512 (e.g., JSON format).

Similarly, a radio question class (not shown) may be included in embodiments to support message mapper class 614 and question DTO class 620 by translating radio button questions from the XML message into a format that may be utilized by UI generation component 512 (e.g., JSON format).

Client classes will now be described in further detail. Question service class 630 receives questions (e.g., per question DTO class 620) from UI service component 510 of ePA accelerator 102. Question service class 630 also transmits completed question/answer and information sets back to UI service component 510.

Question factory class 632 parses the received questions to determine types of the questions received by question service class 630 and makes sure the determined question types conform with NPCPD standard question types.

Each of checkbox question class 634, radio question class 636, date question class 638, free text question class 640, and numeric question class 642 supports question factory class 632 by providing the appropriate, respective question type that was determined.

Question controller class 644 determines how to render, and then renders, the questions determined by question factory class 632 in a view for the UI (e.g., in an HTML view) by loading the appropriate HTML view class (listed below) that corresponds to the determined questions from question factory class 632 (e.g., in JSON format). As an ePA requestor, using a dynamically generated UI executing on a computer of ePA requestor systems 104, 106, answers a question, question controller class 632 reads the answer and populates the corresponding question with the answer for transmission back to ePA accelerator 102 by question service class 630. Question controller class 644 also manages the navigation of the question set based on the answers entered, allowing a dynamic generation of the next question (e.g., a UI portion) to be displayed also based on the type of the next question determined by question factory class 632.

Each of multi-select html class 646, single-select html class 648, date html class 650, free text html class 652, and numeric html class 654 include HTML fragments to support question controller class 644 by providing the appropriate HTML view.

Accordingly, client class structure 604, e.g., through implementation of the described question factory class 632 and question controller class 644, along with their respective supporting classes, provides the ability to dynamically generate question views (e.g., UI portions) based, at least in part, on answers to preceding questions. In this way, a library of forms for specific instances of each and every question and/or format thereof that could be posed by an ePA provider is unnecessary, allowing for a more efficient, automated ePA request/response process. In other words, the combination of client class structure 604 and server class structure 602, together with the hub model implementation described in embodiments herein, allows for any number of ePA provider systems 112, 114 to communicate with any number of ePA requestor systems 104, 106 using any number of different question formats or content for each of ePA provider systems 112, 114, while still maintaining seamless, dynamic generation of UIs presented to ePA requestors using ePA requestor systems 104, 106 without adding complexity to the ePA requestor systems and/or processes.

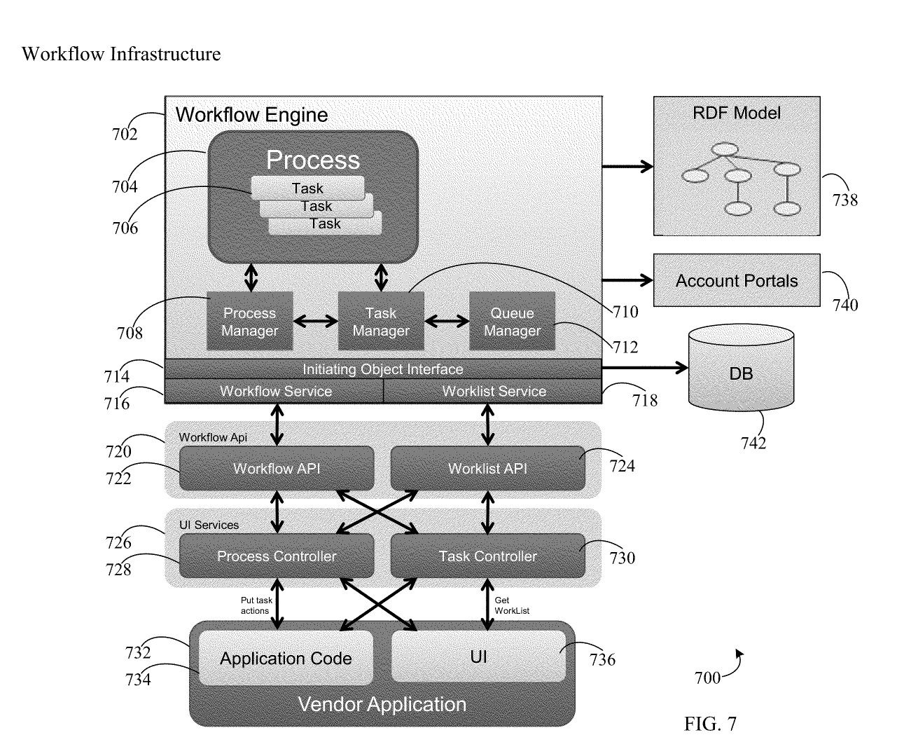

FIG. 7 shows an example architectural diagram of a workflow infrastructure 700 that includes a workflow engine 702 integrated with the inventive ePA accelerator 102 embodiments described herein to manage a given ePA process 704 and its associated tasks 706. For instance, a computer of a user or ePA requestor systems 104, 106 may execute a vendor application 732, in embodiments, that implements a set of API's (an application code API 734 and a UI API 736) which make calls for functionality of ePA accelerator 102 embodiments implemented at or in servers via a series of uniform resource locators (URLs). These URLs communicate with either a process controller 728 or a task controller 730 in a UI services component 726 (which may be an embodiment of UI service component 510 of FIG. 5) depending on the scope of the request the ePA requestor is making. The appropriate controller then passes the request on to a workflow API component 720 that includes a workflow API 722 and a worklist API 724. The appropriate API of workflow API component 720 receives the request, and in turn communicates with the corresponding service: a workflow service 716 or a worklist service 718. Workflow service 716 is responsible for processing the requested action against either a process or a task. These actions include, without limitation, the following: cancelling a process; accepting, completing, releasing, or cancelling a task. Worklist service 718 is responsible for the retrieval of a process list, process details, and/or the active worklist of the current user (ePA requestor).

Interaction at the service level of workflow engine 702 may take place against a series of managers (a process manager 708, a task manager 710, and a queue manager 712) that interact with the corresponding process or task instances. Instance-specific information may be passed to processing engine 702 via an initiating object interface 714 which is an interface controller implemented in order to pass the relevant information, e.g., description of the task, to whom or what entity is the task assigned, a completion date, an authorization number, etc., supplied from the user to ePA accelerator 102 embodiments through the API definition. In workflow engine 702, process manager 708, and task manager 710 are configured to consult with an RDF model 738 and interpret RDF model 738 to determine necessary actions. Necessary actions include, without limitation, determining a next task, creating an instance of the next task, and distributing the next task, and, as noted, may be based on RDF model 738. Following the interpretation and instantiation of the appropriate process/tasks, the instance of the object is persisted to a database (DB) 742 (which may be an embodiment of DB 508 of FIG. 5) with the appropriate state. As the process progresses and tasks are completed, clones of the existing tasks are created with their new state and associated details, and are persisted back to the database. This workflow infrastructure 700 architecture allows for persisting the state of the objects, and also for an audit trail as to the specific interactions taken against the ePA adjudication flow, and by whom, for state tracking and modeling.

Account portals 740 allow for authentication of users to ePA accelerator 102 embodiments. Queue manager 712 is configured to prioritize pending tasks based on, e.g., required completion dates, to close out tasks that pass their required completion date, to distribute the next task that is queued, and to provide a notification of the cancelled task.

It is also contemplated that more than one RDF model may be stored in RDF model 738. For example, changes to the NCPDP standard may require that a new, updated RDF model be created and stored for implementation on the date of the forthcoming standard change.

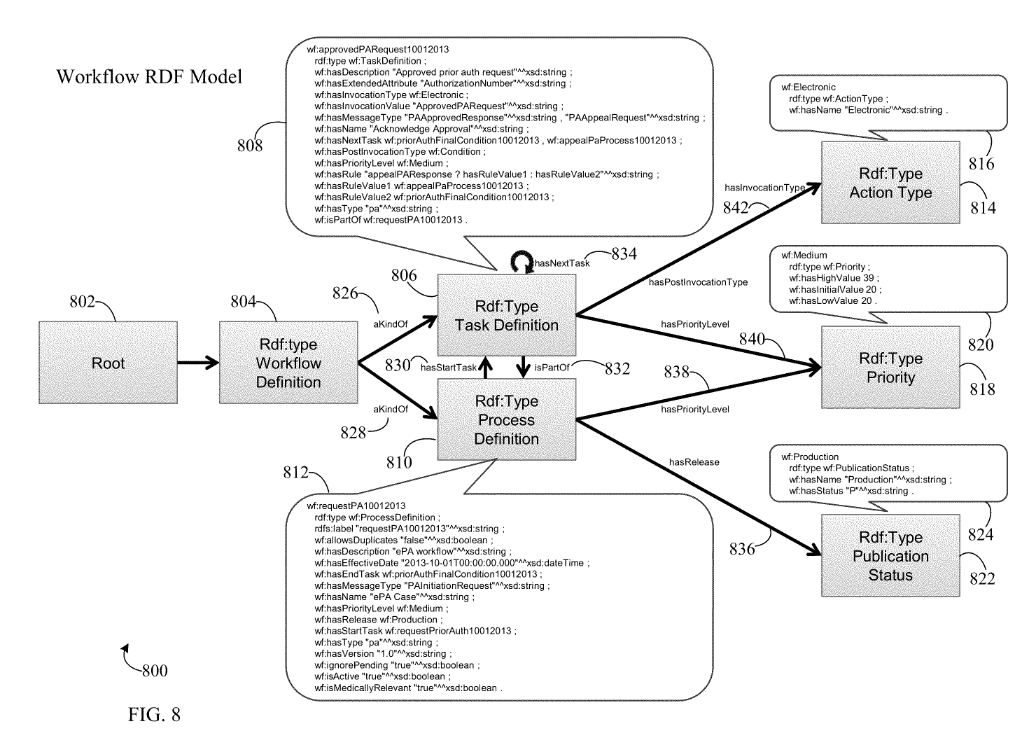

FIG. 8 shows an example high level diagram of a portion of an exemplary workflow RDF model 800 layout which utilizes an RDF model (e.g., RDF model 738) configured to drive the behavior of workflow engine 702 of FIG. 7. Workflow RDF model 800 is broken into a series of components of which a workflow definition object 804, derived from a root workflow model object 800, is the base object from which both a process definition 810 (linked by an a-kind-of slot 828) and a task definition 806 (linked by an a-kind-of slot 826) inherit their respective common properties 812 and 808. Process definition 810 may possess a one-to-many relationship where an is-part-of slot 832 links process definition 810 with its corresponding task definitions 806. In other words, a given process (e.g., process 704 of FIG. 7) may have multiple tasks (e.g., tasks 706 of FIG. 7), and therefore a corresponding one-to-many relationship may exist between process definition 810 and its corresponding task definitions 806. The starting tasks for the process are defined via a has-start-task slot 830 embedded within process definition 810. The follow on tasks are captured within task definition 806 in a has-next-task slot 834. Each of the described slots may support a “1:n” correlation. While only one task definition 806 is shown, it is contemplated that more than one task definition 806 may be implemented in embodiments for any given process definition 810.

Within process definition 810 may lie all of the remaining defining constructs to support the instantiation of a single process of the defined type. Associated with a process are two additional objects that support a defined collection of priority levels 818 (linked by has-priority-level slot 838), an example 820 is shown, and publication statuses 822 (linked by has-release slot 836) that are then associated with process definition 810 to define its level of priority/importance and corresponding delivery level (e.g., development, QA, or production, as in example 824). Like process definition 810, task definition 806 may also contain all of the defining constructs to support the instantiation of a task instance and the behavior it is to exhibit. Associated with a task are two additional objects that support defined collection of priority levels 818 (linked by has-priority-level slot 840) and action types 814 (linked by has-invocation-type/has-post-invocation-type slot 842) that are then associated with task definition 806 to define its levels of priority/importance and its corresponding action it is to execute against, examples of which are electronic interaction operands, as shown in example 816, such as AND, OR, XOR, as well as external method interaction. Finally, within task definition 806 is the definition of the rules to be executed upon in workflow engine 702 of FIG. 7, which result in decisions being made which drive to the specific collection of next tasks to be initiated.

### Example Operational Embodiments

Systems and apparatuses utilizing ePA accelerator techniques as described herein may, without limitation, perform their functions according to the exemplary operational embodiments described in this Section.

For instance, FIG. 9 shows an exemplary transaction flow 900 for facilitating the provision of an ePA by PBM system 516 of FIG. 5, an embodiment of ePA provider systems 112, 114 of FIG. 1, to an ePA requestor or a user 960 of ePA requestor systems 104, 106 in accordance with the ePA accelerator 102 embodiments herein. That is, ePA accelerator 102 and ePA accelerator components 522 may operate in accordance with transaction flow 900. Messages (e.g., ePA requests and ePA responses) traverse the ePA accelerator 102 embodiments between PBM system 516 and browser 514 of computers of ePA requestor systems 104, 106. Different ePA accelerator components 522 of ePA accelerator 102 embodiments perform functions at various points in the transaction as described herein.

As shown, user 960 may begin the process via an application that may include browser 514 which may be used to access a network (e.g., network 116) such as the Internet. At 902, user 960 transmits an ePA initiation request that is received by message processing component 502. At 904, message processing component 502 saves the received request message. In embodiments, the saved request message may be provided to windows service component 504 and to DB 508 (shown in FIG. 5) for state tracking and modeling as described herein. At 906, a create process message is provided to message event service component 506, and at 910 workflow task is created for PBM system 516. The creation of the task may be logged for state tracking and modeling as described herein. At 908, message processing component 502 provides an ePA initiation request to PBM system 516.

At 912, PBM system 516 may respond to the ePA initiation request from 908 by providing an ePA initiation response that is received by message processing component 502. The ePA initiation response may include a question set (i.e., a questionnaire) requiring answers and/or information from user 960. Message processing component 502 provides an invoke process message to message event service component 506 at 914, and at 918, the task created at 910 is closed, while a task is created for user 960 at 920. At 916, message processing component 502 provides an informational message to user 960 via browser 514 that a response to the ePA initiation request has been received.

At 922, user 960 requests a worklist associated with ePA initiation response from message event service component 506 via UI generation component 512. A worklist response is presented via UI generation component 512 from message event service component 506, and the requested worklist is displayed to user 960 at 924.

At 926, user 960 selects a worklist task via UI generation component 512, and a get question message is provided to UI service component 510. In response, at 928 UI service component 510 provides a task message to UI generation component 512, and UI service component 510 creates a questionnaire response at 930. In embodiments, the questionnaire response includes a representation of the question set provided in the ePA initiation response at 912 in a format of JavaScript, JSON, HTML, and/or the like, to be utilized by UI generation component 512. At 932, UI service component 510 provides the questionnaire response to UI generation component 512. In embodiments, UI generation component 512 generates a UI or portion thereof within browser 514 for presenting to user 960. The representation of the question set provided at 930 may be provided in the UI or portion thereof.

Responsive to the display of the representation of the question set provided at 930, user 960 may answer questions and/or provide requested information via UI generation component 512 within browser 514. This is exemplarily embodied by UI 400 of FIG. 4. UI generation component 512 is configured to dynamically generate portions of the UI to be displayed next for user 960 in response to user 960 entering information and/or answering questions provided in the UI. In embodiments, this dynamic generation is performed using client class structure 604 of FIG. 6. Upon completion of information entry and question answering by user 960 at 934 the answers and information are provided to UI service component 510 which provides a task message response at 936. At 938, UI service component 510 builds an ePA request to be provided to PBM system 516. In embodiments, the answers and information received at 934 may be in a non-XML format, such as JavaScript, JSON, HTML, and/or the like, similar to the created questionnaire response at 930. UI service component 510 is configured to build the ePA request so that it conforms to the NCPDP XML standard. At 940, the ePA request is provided to message processing component 502, and at 948, the ePA request is provided to PBM system 516 in accordance with the NCPDP XML standard. At 942, an invoke process message is provided to message event service component 506, at 944 the task created at 920 is closed, and at 946 a new task is created for PBM system 516. The closing and creation of tasks at 944 and 946 may be logged for state tracking and modeling as described herein.

At 950, PBM system 516) provides an ePA response that is received by message processing component 502. The ePA response is parsed by ePA accelerator 102, e.g., by message processing component 502, and tasks in the ePA request/response process may be updated accordingly. Message processing component 502 sends and invoke process message to message event service component 506 at 952, and at 954, message event service component 506 closes the task created at 946. The closing of the task at 954 may be logged and used for tracking and modeling the process state. At 956, an informational message related to the ePA response is provided to user 960 via browser 514.

At 958, a worklist request may be sent from UI generation component 512 to message processing component 502 to provide and updated worklist that reflects the current state of the ePA process. It should be noted that the ePA response provided at 950 may indicate that additional information is required to make an ePA determination. In such cases, the ePA response may include additional questions and requests for information in a questionnaire similar to that provided by PBM system 516 at 912. Accordingly, one or more iterations of the process described above, but beginning at 912, may take place until an ePA provider using PBM system 516 has sufficient information to make a determination regarding the ePA request. Once a determination is made, the ePA response at 950 may indicate that the ePA request is, without limitation: approved, denied, deferred, and/or closed (e.g., due to the patient associated with the ePA request no longer being affiliated with the ePA provider using PBM system 516).

In some embodiments, one or more of steps of transaction flow 900 may not be performed. Moreover, steps in addition to or in lieu of steps of transaction flow 900 may be performed (some of which were described above). Further, in some example embodiments, one or more of steps of transaction flow 900 may be performed out of the order shown in FIG. 9, in an alternate sequence, and/or partially (or completely) concurrently with other steps.

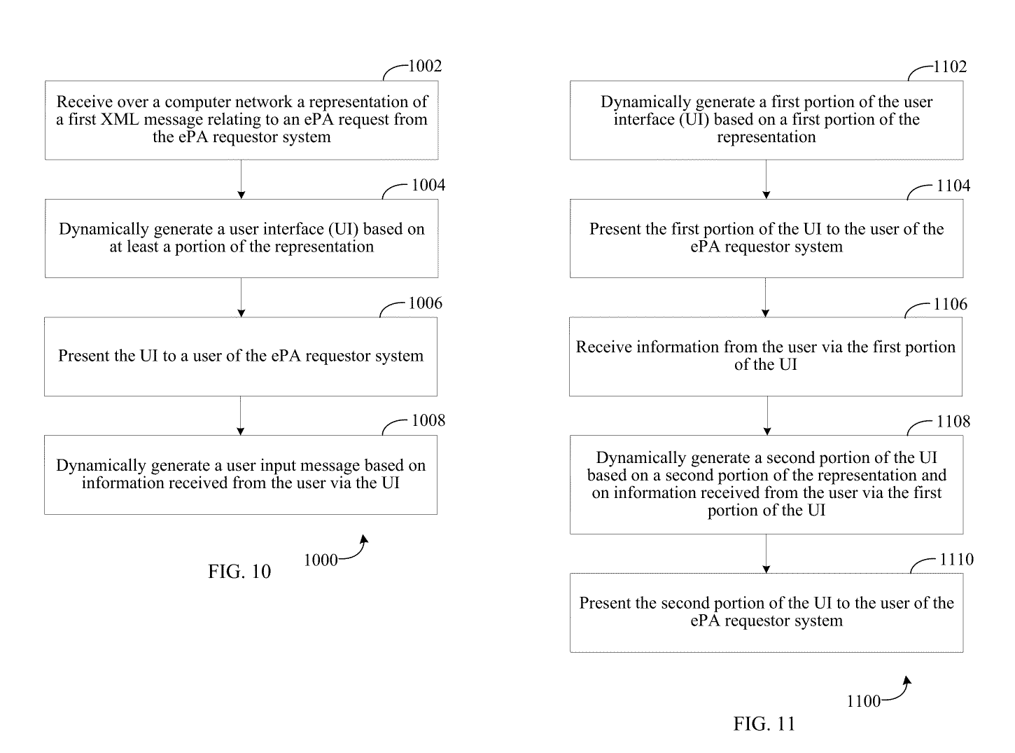

In FIGS. 10 and 11, flowcharts 1000 and 1100 respectively are shown providing example steps for dynamic generation of a UI. All or portions of UI 108 and UI 110 of FIG. 1, all or portions of UI 400 of FIG. 4 may be dynamically generated according to flowcharts 1000 and/or 1100. UI generation component 512 of FIG. 5, client class structure 604 of FIG. 6, application code API 734 and UI API 736 of FIG. 7, and/or any of their respective components and sub-components may operate in accordance with flowcharts 1000 and/or 1100, in embodiments. In some embodiments, flowchart 1100 may comprise steps in furtherance of steps in flowchart 1000. Other structural and operational embodiments will be apparent to persons skilled in the relevant art(s) based on the discussion regarding flowcharts 1000 and/or 1100. Flowchart 1000 is described as follows.

In embodiments, flowchart 1000 may be a method executed by a computer or may be a method performed by a processing device in accordance with computer program instructions encoded on a computer-readable storage medium, where the method is for facilitating the delivery of an electronic prior authorization (ePA) by an ePA provider system to an ePA requestor system. Flowchart 1000 may be a method performed by one or more computers, such as, but without limitation, server computers that may be part of a distributed server configuration.

Flowchart 1000 begins with step 1002. At step 1002, a representation of a first XML message relating to an ePA request from the ePA requestor system is received over a computer network. For example, an XML message such an ePA response or an ePA initiation response that is related to an ePA request may be transmitted over a network, e.g., network 116 of FIG. 1, from ePA provider systems 112, 114 of FIG. 1. In embodiments, the XML message may be received by an ePA accelerator such as ePA accelerator 102 of FIG. 1. ePA accelerator 102 is configured to generate a representation of the XML message and provide the representation to ePA requestor systems 104, 106 of FIG. 1, where the representation may be received by a UI generation component (e.g., UI generation component 512 of FIG. 5 and/or application code API 734 and UI API 736 of FIG. 7) in UI 108, 110.

At step 1004, a user interface (UI) is dynamically generated based on at least a portion of the representation. For example, a UI generation component (e.g., UI generation component 512 of FIG. 5 and/or application code API 734 and UI API 736 of FIG. 7) may dynamically generate a UI or portion thereof such as question area 406 of FIG. 4 based on information in the representation of the XML message. The dynamic generation may be performed in accordance with client class structure 604 of FIG. 6, as described above. In embodiments, UI generation component 512, application code API 734, UI API 736, and/or client class structure 604 may be embedded in vendor application 732 (of FIG. 7) in a browser or the like of an ePA requestor system or computer.

At step 1006, the UI is presented to a user of the ePA requestor system. For instance, the dynamically generated UI of step 1004 may be presented for viewing to an ePA requestor or user, e.g., at UI 108, 110 of FIG. 1, and/or by UI generation component 512 of FIG. 5 or UI component 736 of FIG. 7. In embodiments, one or more of UI 108, 110, UI generation component 512, and UI component 736 may be embedded in a vendor application 732 (of FIG. 7) in a browser or the like of an ePA requestor system or computer.

At step 1008, a user input message is dynamically generated based on information received from the user of the UI. For instance, UI 108, 110, UI generation component 512, and/or UI component 736 may receive user inputs via the UI generated in step 1004 and presented in step 1006. As a user provides inputs via the UI, the inputs are received and a user input message is dynamically generated that may subsequently be transmitted to an ePA accelerator (e.g., ePA accelerator 102 of FIG. 1) or components thereof when the user's interaction with the UI is completed. UI 108, 110, UI generation component 512, and/or UI component 736 may also dynamically check or validate the user inputs to ensure the inputs conform to expected input types and/or content based on what is presented to the user in the UI in step 1006.

In some example embodiments, one or more of steps 1002, 1004, 1006, and/or 1008 of flowchart 1000 may not be performed. Moreover, steps in addition to or in lieu of steps 1002, 1004, 1006, and/or 1008 of flowchart 1000 may be performed (some of which were described above). Further, in some example embodiments, one or more of steps 1002, 1004, 1006, and/or 1008 of flowchart 1000 may be performed out of the order shown in FIG. 10, in an alternate sequence, and/or partially (or completely) concurrently with other steps.

Turning now to FIG. 11, flowchart 1100 may be a method executed by a computer or may be a method performed by a processing device in accordance with computer program instructions encoded on a computer-readable storage medium, where the method is for facilitating the delivery of an electronic prior authorization (ePA) by an ePA provider system to an ePA requestor system. Flowchart 1100 may be a method performed by one or more computers, such as server computers. The dynamic generation described in flowchart 1100 may be performed in accordance with client class structure 604 of FIG. 6, as described above. In embodiments, UI generation component 512, application code API 734, UI API 736, and/or client class structure 604 may be embedded in vendor application 732 (of FIG. 7) in a browser or the like of a vendor system or computer.

Flowchart 1100 begins with step 1102. At step 1102, a first portion of the UI is dynamically generated based on a first portion of the representation. In embodiments, a UI as described herein, may include one or more areas of content through which a user such as an ePA requestor may provide inputs. In embodiments, each area of content may include one or more questions and/or requests for data corresponding to portions of question sets sent in XML messages from ePA provider systems, and different areas of content may be sequentially presented to a user upon completion of the previous area. An exemplary area of content is shown in FIG. 4 as question area 406. The question provided in question area 406 is Question 1 of 6. When a representation of an XML message is received, the first area of content may be dynamically generated based on a first portion of the representation, e.g., by UI generation component 512 of FIG. 5 and/or application code API 734 and UI API 736 of FIG. 7.

At step 1104, the first portion of the UI is presented to the user of the ePA requestor system. For instance, the first portion may be presented for viewing on an embedded UI or UI portion in an application executing on a computer of an ePA requestor system as similarly described above with respect to step 1006 of flowchart 1000.

At step 1106, information is received from the user via the first portion of the UI. In embodiments, such information may be referred to as user input. Referring back to question area 406 of FIG. 4, an ePA requestor (i.e., user) may answer a question displayed in question area 406 by appropriate selection of radio button, check box, alpha-numeric character entry, selection of selectable list content, and/or the like. When the ePA requestor finishes answering the question and/or inputting information, the next question may be selected at which time, the user input is received.

At step 1108, a second portion of the UI is dynamically generated based on a second portion of the representation and on information received from the user via the first portion of the UI. For example, the received user input and another portion of the representation may be used to dynamically generate a second portion of the UI. In embodiments, such as question area 406, Question 2 of 6 may be dynamically generated based on the XML message representation and the user's answer to Question 1 of 6, e.g., by UI generation component 512 of FIG. 5 and/or application code API 734 or UI API 736 of FIG. 7.

At step 1110, the second portion of the UI is presented to the user of the ePA requestor system. For instance, the second portion may be presented for viewing on an embedded UI or UI portion in an application executing on a computer of an ePA requestor system as similarly described above with respect to step 1006 of flowchart 1000 and/or step 1104.

In some example embodiments, one or more of steps 1102, 1104, 1106, 1108, and/or 1110 of flowchart 1100 may not be performed. Moreover, steps in addition to or in lieu of steps 1102, 1104, 1106, 1108, and/or 1110 of flowchart 1100 may be performed (some of which were described above). Further, in some example embodiments, one or more of steps 1102, 1104, 1106, 1108, and/or 1110 of flowchart 1100 may be performed out of the order shown in FIG. 11, in an alternate sequence, and/or partially (or completely) concurrently with other steps.

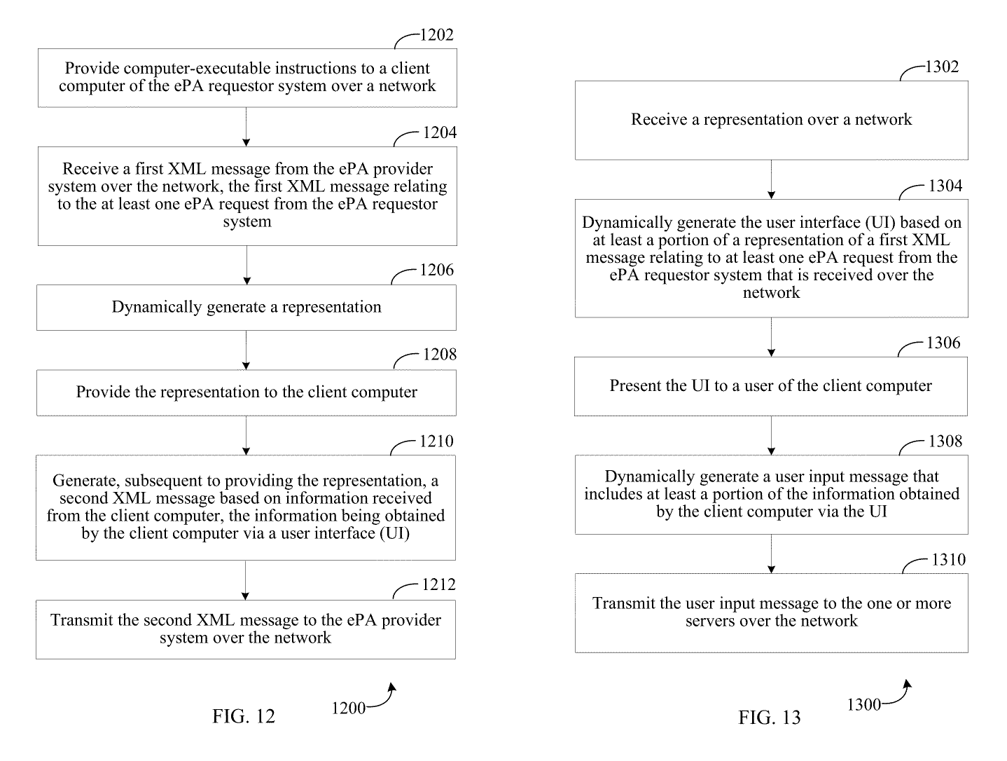

In FIGS. 12 and 13, flowcharts 1200 and 1300 respectively are shown providing example steps for facilitating the delivery of at least one electronic prior authorization (ePA) by an ePA provider system to an ePA requestor system. ePA accelerator 102 of FIG. 1, and components thereof, may operate in accordance with flowcharts 1200 and/or 1300, in embodiments. In some embodiments, flowchart 1300 may comprise steps in furtherance of steps in flowchart 1200. Other structural and operational embodiments will be apparent to persons skilled in the relevant art(s) based on the discussion regarding flowcharts 1200 and/or 1300. Flowchart 1200 is described as follows.

In embodiments, flowchart 1200 may be a method executed by a computer or may be a method performed by a processing device in accordance with computer program instructions encoded on a computer-readable storage medium, where the method is for facilitating the delivery of an electronic prior authorization (ePA) by an ePA provider system to an ePA requestor system. Flowchart 1200 may be a method performed by one or more computers, such as server computers.

Flowchart 1200 begins with step 1202. At step 1202, computer-executable instructions are provided to a client computer of the ePA requestor system over a network. In embodiments, the instructions, when executed at the client computer, perform a client-side method comprising: dynamically generating a user interface (UI) based on at least a portion of a representation of a first XML message relating to at least one ePA request from the ePA requestor system that is received over the network. In some embodiments, the client-side method may include some or all of the steps of flowchart 1000 of FIG. 10 and/or of flowchart 1100 of FIG. 11, as described above. For example, ePA accelerator 102 may be configured to provide the computer executable instructions to a computer of ePA requestor systems 104, 106 via network 116.

At step 1204, a first XML message is received from the ePA provider system over the network, the first XML message relating to the at least one ePA request from the ePA requestor system. For example, ePA accelerator 102 may be configured to receive an XML message from ePA provider system 112 or 114. The first XML message may be transmitted from the ePA provider system responsive to the ePA provider system receiving an ePA initiation request or an ePA request, and may contain one or more question sets relating to an ePA. In embodiments, the first XML message may be formatted according to the NPCDP XML message standard.

At step 1206, a representation is dynamically generated. For instance, ePA accelerator 102 may be configured to dynamically generate the representation by processing the XML message (e.g., using message processing component 502 of FIG. 5), generating tasks and informational messages based on the processed XML message (e.g., using windows service 504 and message event service 506 of FIG. 5, respectively), and dynamically generating a non-XML version of the message such as JavaScript, JSON, HTML, etc. based on the informational message and tasks (e.g., using UI services component 510).

At step 1208, the representation is provided to the client computer. For instance, ePA accelerator 102 may be configured to provide the representation to a client computer of ePA requestor system 104 or 106 via network 116, as shown in FIG. 1 and as described with respect to FIG. 9.

At step 1210, a second XML message is generated, subsequent to providing the representation, based on information received from the client computer, the information being obtained by the client computer via a user interface (UI). In embodiments, ePA accelerator 102 may be configured to generate the second XML message. For example, UI services component 510 may receive the information from the client computer and generate the second XML message (e.g., according to the NPCDP XML message standard). The second XML message may subsequently be transmitted from ePA accelerator 102 via network 116 to ePA provider system 112 or 114.

At step 1212, the second XML message is transmitted to the ePA provider system over the network. For example, message processing component 502 may transmit the second XML message to ePA provider systems 112, 114 over network 116.

In some example embodiments, one or more of steps 1202, 1204, 1206, 1208, 1210, and/or 1212 of flowchart 1200 may not be performed. Moreover, steps in addition to or in lieu of steps 1202, 1204, 1206, 1208, 1210, and/or 1212 of flowchart 1200 may be performed (some of which were described above). Further, in some example embodiments, one or more of steps 1202, 1204, 1206, 1208, 1210, and/or 1212 of flowchart 1200 may be performed out of the order shown in FIG. 12, in an alternate sequence, and/or partially (or completely) concurrently with other steps.

Turning now to FIG. 13, flowchart 1300 may be a method executed by a computer or may be a method performed by a processing device in accordance with computer program instructions encoded on a computer-readable storage medium, where the method is for facilitating the delivery of an electronic prior authorization (ePA) by an ePA provider system to an ePA requestor system. The dynamic generation described in flowchart 1300 may be performed in accordance with client class structure 604 of FIG. 6, as described above. In embodiments, UI generation component 512, application code API 734 or UI API 736, and/or client class structure 604 may be embedded in vendor application 732 (of FIG. 7) in a browser or the like of a vendor system or computer. One of more steps of flowchart 1300 may be a further embodiment of step 1202 of flowchart 1200 of FIG. 12. Flowchart 1300 is described as follows.

Flowchart 1300 begins with step 1302. At step 1302, a representation is received over a network. In embodiments, the representation may be the dynamically generated representation of step 1206 of flowchart 1200, and the network may be network 116 of FIG. 1. The representation may be provided by UI service component 510 to UI generation component 512 of FIG. 5.

At step 1304, a UI is dynamically generated based on at least a portion of a representation of a first XML message relating to at least one ePA request from the ePA requestor system that is received over the network. In embodiments, step 1304 may be performed in a similar manner as step 1004 of flowchart 1000 and/or step 1102 of flowchart 1100. A UI as described herein, may include one or more areas of content through which a user such as an ePA requestor may provide inputs. In embodiments, each area of content may include one or more questions and/or requests for data corresponding to portions of question sets sent in XML messages from ePA provider systems, and different areas of content may be sequentially presented to a user upon completion of the previous area. An exemplary area of content is shown in FIG. 4 by question area 406. When a representation of an XML message is received, the first area of content may be dynamically generated based on a first portion of the representation, e.g., by UI generation component 512 of FIG. 5 and/or application code API 734 or UI API 736 of FIG. 7.

At step 1306, the UI is provided to a user of the client computer. For instance, the first portion may be presented for viewing on an embedded UI in an application executing on a computer of an ePA requestor system as similarly described above with respect to step 1006 of flowchart 1000.

At step 1308, a user input message is dynamically generated that includes at least a portion of the information obtained by the client computer via the UI. For example, the received user input may be obtained by UI generation component 512 according to the operation described with respect to client class structure 604 of FIG. 6, and a user input message may be subsequently generated.

At step 1310, the user input message is transmitted to the one or more servers over the network. For instance, the user input message may be transmitted from UI generation component 512 to UI service component 510 of FIG. 5 of ePA accelerator 102. The user input message may be subsequently used to generate the second XML message of step 1210 of flowchart 1200.

In some example embodiments, one or more of steps 1302, 1304, 1306, 1308, and/or 1310 of flowchart 1300 may not be performed. Moreover, steps in addition to or in lieu of steps 1302, 1304, 1306, 1308, and/or 1310 of flowchart 1300 may be performed (some of which were described above). Further, in some example embodiments, one or more of steps 1302, 1304, 1306, 1308, and/or 1310 of flowchart 1300 may be performed out of the order shown in FIG. 13, in an alternate sequence, and/or partially (or completely) concurrently with other steps.

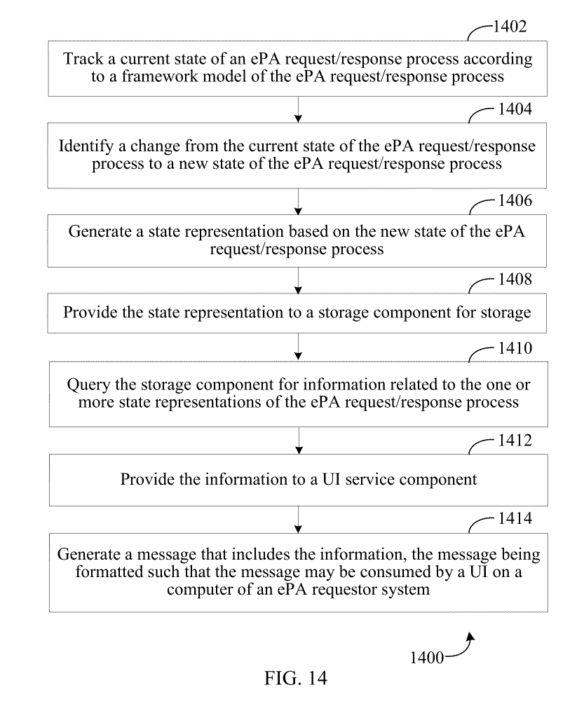

In FIG. 14, flowchart 1400 is shown providing example steps modeling the state of an electronic prior authorization (ePA) request/response process. ePA accelerator 102 of FIG. 1, and components thereof, may operate in accordance with flowchart 1400 in embodiments. Other structural and operational embodiments will be apparent to persons skilled in the relevant art(s) based on the discussion regarding flowchart 1400. Flowchart 1400 is described as follows.

In embodiments, flowchart 1400 may be a method executed by a computer or may be a method performed by a processing device in accordance with computer program instructions encoded on a computer-readable storage medium, where the method is for modeling the state of an electronic prior authorization (ePA) request/response process. Flowchart 1400 may be a method performed by one or more computers, such as server computers, that are configured to process instructions and store data and/or information related to the execution of flowchart 1400.

Flowchart 1400 begins with step 1402. At step 1402, a current state of an ePA request/response process is tracked according to a framework model of the ePA request/response process. In embodiments, the framework model is a model of the ePA request/response process based at least in part on a framework (e.g., RDF), and may be dynamically generated and stored by ePA accelerator 102 of FIG. 1, e.g., by windows service component 504 and/or message event service component 506 in DB 508 of FIG. 5.

At step 1404, a change from the current state of the ePA request/response process to a new state of the ePA request/response process is identified. In embodiments, ePA accelerator 102, e.g., by windows service component 504 and/or message event service component 506 of FIG. 5, may be configured to identify changes in the current state based on received XML messages from ePA provider system 112 or 114, from user input messages received from ePA requestor systems 104, 106 via UI 108, 110, and/or from internal ePA accelerator 102 task and message processing. For example, referring to FIG. 9 and transaction flow 900, ePA accelerator 102 may identify when an ePA request/response process progresses from one stage of transaction flow 900 to the next stage.

At step 1406, a state representation is generated based on the new state of the ePA request/response process. For instance, ePA accelerator 102, e.g., by windows service component 504 and/or message event service component 506 of FIG. 5, may be configured to generate a state representation of the new state. In embodiments, the new state representation may be realized in the form of tasks and/or message that are newly created to be distributed to appropriate entities in the ePA request/response process.

At step 1408, the state representation is provided to a storage component for storage. For instance, ePA accelerator 102 may be configured to include database 508 which may store new state representation information such as the newly created tasks and/or messages.

At step 1410, the storage component is queried for information related to the one or more state representations of the ePA request/response process. In embodiments, a task list request for ePA providers or ePA requestors may be received from ePA provider systems 112, 114 or ePA requestor systems 104, 106 respectively. In response, DB 508 may be queried for current and/or past state representations that may be subsequently provided to the requesting entity for viewing and/or selection.

At step 1412, the information is provided to a UI service component. For example, the result of the query in step 1410 is provided from DB 508 to UI service component 510.

At step 1414, a message that includes the information is generated, the message being formatted such that the message may be utilized by a UI on a computer of an ePA requestor system. In embodiments, UI service component 510 may generate the message in a JavaScript, JSON, and/or HTML format, or the like, and provide the message to UI generation component 512 for viewing and/or selection.

As noted in step 1410, an ePA provider using an ePA provider system may request a task list that includes ePA process state information. Accordingly, it is contemplated that additional steps similar to steps 1412 and 1414 may be performed for providing task and state information to an ePA provider system commensurate with embodiments described herein.

In some example embodiments, one or more of steps 1402, 1404, 1406, 1408, 1410, 1412, and/or 1414 of flowchart 1400 may not be performed. Moreover, steps in addition to or in lieu of steps 1402, 1404, 1406, 1408, 1410, 1412, and/or 1414 of flowchart 1400 may be performed (some of which were described above). Further, in some example embodiments, one or more of steps 1402, 1404, 1406, 1408, 1410, 1412, and/or 1414 of flowchart 1400 may be performed out of the order shown in FIG. 14, in an alternate sequence, and/or partially (or completely) concurrently with other steps.

### Further Example Embodiments

A device, as defined herein, is a machine or manufacture as defined by 35 U.S.C. §101. Devices may be digital, analog or a combination thereof. Devices may include integrated circuits (ICs), one or more processors (e.g., central processing units (CPUs), microprocessors, digital signal processors (DSPs), etc.) and/or may be implemented with any semiconductor technology, including one or more of a Bipolar Junction Transistor (BJT), a heterojunction bipolar transistor (HBT), a metal oxide field effect transistor (MOSFET) device, a metal semiconductor field effect transistor (MESFET) or other transconductor or transistor technology device. Such devices may use the same or alternative configurations other than the configuration illustrated in embodiments presented herein.

Techniques and embodiments, including methods, described herein may be implemented in hardware (digital and/or analog) or a combination of hardware and software and/or firmware. Techniques described herein may be implemented in one or more components. Embodiments may comprise computer program products comprising logic (e.g., in the form of program code or instructions as well as firmware) stored on any computer useable storage medium, which may be integrated in or separate from other components. Such program code, when executed in one or more processors, causes a device to operate as described herein. Devices in which embodiments may be implemented may include storage, such as storage drives, memory devices, and further types of computer-readable media. Examples of such computer-readable storage media include, but are not limited to, a hard disk, a removable magnetic disk, a removable optical disk, flash memory cards, digital video disks, random access memories (RAMs), read only memories (ROM), and the like. In greater detail, examples of such computer-readable storage media include, but are not limited to, a hard disk associated with a hard disk drive, a removable magnetic disk, a removable optical disk (e.g., CDROMs, DVDs, etc.), zip disks, tapes, magnetic storage devices, MEMS (micro-electromechanical systems) storage, nanotechnology-based storage devices, as well as other media such as flash memory cards, digital video discs, RAM devices, ROM devices, and the like. Such computer-readable storage media may, for example, store computer program logic, e.g., program modules, comprising computer executable instructions that, when executed, provide and/or maintain one or more aspects of functionality described herein with reference to the figures, as well as any and all components, steps and functions therein and/or further embodiments described herein.

Computer readable storage media are distinguished from and non-overlapping with communication media. Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wired media as well as wireless media such as acoustic, RF, infrared and other wireless media. Example embodiments are also directed to such communication media.

The ePA accelerator embodiments and/or any further systems, sub-systems, and/or components disclosed herein may be implemented in hardware (e.g., hardware logic/electrical circuitry), or any combination of hardware with software (computer program code configured to be executed in one or more processors or processing devices) and/or firmware.

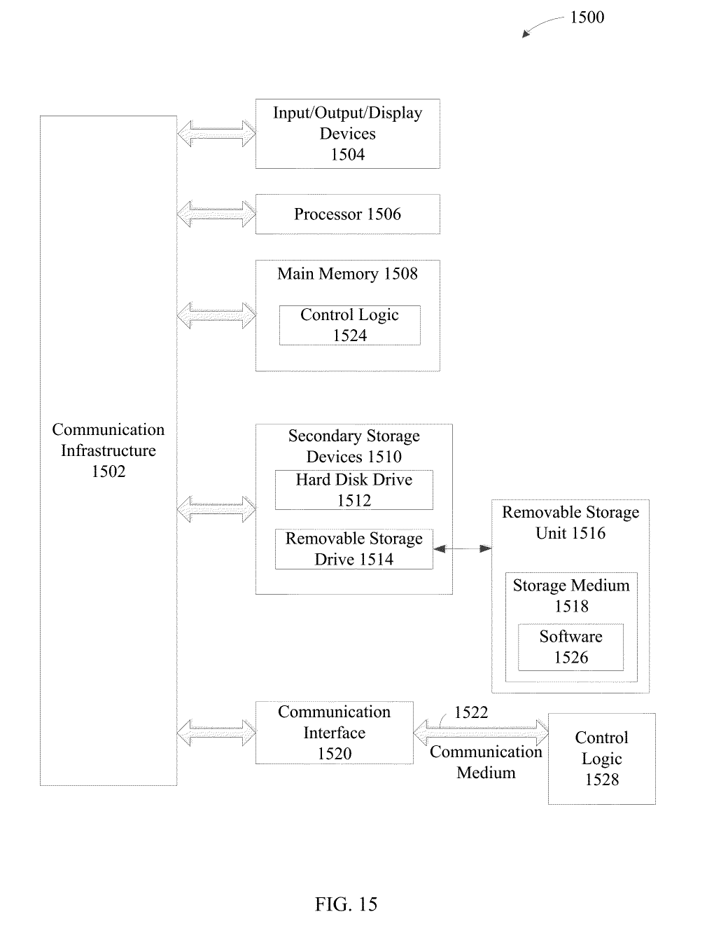

The embodiments described herein, including systems, methods/processes, and/or apparatuses, may be implemented using well known processing devices, telephones (smart phones and/or mobile phones), servers, and/or, computers, such as a computer 1500 shown in FIG. 15. It should be noted that computer 1500 may represent communication devices, processing devices, servers, and/or traditional computers in one or more embodiments. For example, the ePA accelerator 102 embodiments, and any of the sub-systems or components respectively contained therein, may be implemented using one or more computers 1500. Likewise, ePA provider systems 112, 114, ePA requestor systems 104, 106, and/or any respective components or sub-components thereof, may be implemented using one or more computers 1500.

Computer 1500 can be any commercially available and well known communication device, processing device, and/or computer capable of performing the functions described herein, such as devices/computers available from International Business Machines®, Apple®, Sun®, HP®, Dell®, Cray®, Samsung®, Nokia®, etc. Computer 1500 may be any type of computer, including a desktop computer, a server, etc.

Computer 1500 includes one or more processors (also called central processing units, or CPUs), such as a processor 1506. Processor 1506 is connected to a communication infrastructure 1502, such as a communication bus. In some embodiments, processor 1506 can simultaneously operate multiple computing threads.

Computer 1500 also includes a primary or main memory 1508, such as random access memory (RAM). Main memory 1508 has stored therein control logic 1524 (computer software), and data.

Computer 1500 also includes one or more secondary storage devices 1510. Secondary storage devices 1510 include, for example, a hard disk drive 1512 and/or a removable storage device or drive 1514, as well as other types of storage devices, such as memory cards and memory sticks. For instance, computer 1500 may include an industry standard interface, such a universal serial bus (USB) interface for interfacing with devices such as a memory stick. Removable storage drive 1514 represents a floppy disk drive, a magnetic tape drive, a compact disk drive, an optical storage device, tape backup, etc.

Removable storage drive 1514 interacts with a removable storage unit 1516. Removable storage unit 1516 includes a computer useable or readable storage medium 1518 having stored therein computer software 1526 (control logic) and/or data. Removable storage unit 1516 represents a floppy disk, magnetic tape, compact disk, DVD, optical storage disk, or any other computer data storage device. Removable storage drive 1514 reads from and/or writes to removable storage unit 1516 in a well-known manner.

Computer 1500 also includes input/output/display devices 1504, such as touchscreens, LED and LCD displays, monitors, keyboards, pointing devices, etc.

Computer 1500 further includes a communication or network interface 1518. Communication interface 1520 enables computer 1500 to communicate with remote devices. For example, communication interface 1520 allows computer 1500 to communicate over communication networks or mediums 1522 (representing a form of a computer useable or readable medium), such as LANs, WANs, the Internet, etc. Network interface 1520 may interface with remote sites or networks via wired or wireless connections.

Control logic 1528 may be transmitted to and from computer 1500 via the communication medium 1522.

Any apparatus or manufacture comprising a computer useable or readable medium having control logic (software) stored therein is referred to herein as a computer program product or program storage device. This includes, but is not limited to, computer 1500, main memory 1508, secondary storage devices 1510, and removable storage unit 1516. Such computer program products, having control logic stored therein that, when executed by one or more data processing devices, cause such data processing devices to operate as described herein, represent embodiments of the invention.

### CONCLUSION

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A computer-readable storage medium having computer program instructions encoded thereon that, when executed by a processing device, perform a method for facilitating the delivery of an electronic prior authorization (ePA) by an ePA provider system to an ePA requestor system, the method comprising:
receiving over a computer network a representation of a first XML message relating to an ePA request from the ePA requestor system;
dynamically generating a user interface (UI) based on at least a portion of the representation;
presenting the UI to a user of the ePA requestor system; and
dynamically generating a user input message based on information received from the user via the UI.

2. The computer-readable storage medium of claim 1, wherein dynamically generating the UI comprises:
dynamically generating a first portion of the UI based on a first portion of the representation; and
wherein presenting the UI comprises:
presenting the first portion of the UI to the user of the ePA requestor system.

3. The computer-readable storage medium of claim 2, wherein dynamically generating the UI comprises:
dynamically generating a second portion of the UI based on a second portion of the representation and on information received from the user via the first portion of the UI; and
wherein presenting the UI comprises:
presenting the second portion of the UI to the user of the ePA requestor system.

4. The computer-readable storage medium of claim 1, wherein:
the first XML message is in accordance with a National Council for Prescription Drug Programs (NCPDP) message standard, or
the representation is in accordance with a version of a JavaScript language.

5. The computer-readable storage medium of claim 4, wherein the representation comprises a question set; and
wherein dynamically generating the UI comprises:
dynamically generating a first JavaScript implementation of a first question of the question set that includes a first user input field based on a question type of the first question;
determining a second question of the question set based on the representation and a user input that is associated with the first question; and
dynamically generating a second JavaScript implementation of the second question that includes a second user input field based on a question type of the second question.

6. The computer-readable storage medium of claim 5, the method further comprising:
transmitting over the computer network the user input message, content of the user input message being in accordance with the version of the JavaScript language and being formatted for conversion to a second XML message to be transmitted to the ePA provider system.

7. The computer-readable storage medium of claim 6, the method further comprising:
receiving over the computer network an additional representation of a third XML message from an additional ePA provider system in accordance with the NCPDP message standard, the third XML message relating to an additional ePA request from the ePA requestor system and having a different message implementation from the first XML message; and
dynamically generating an additional UI based on at least a portion of the additional representation,
presenting the additional UI to the user of the ePA requestor system,
dynamically generating an additional user input message based on additional information received from the user via the additional UI; and
transmitting over the computer network the additional user input message, content of the additional user input message being in accordance with the version of the JavaScript language and being formatted for conversion to a fourth XML message to be transmitted to the additional ePA provider system.

8. A system for modeling the state of an electronic prior authorization (ePA) request/response process, comprising:
at least one processor;
at least one storage component configured to:
persistently store a framework model of the ePA request/response process, and
persistently store one or more state representations; and
a state modeling component, executing on the at least one processor, that is configured to:
track a current state of the ePA request/response process according to the model,
identify a change from the current state of the ePA request/response process to a new state of the ePA request/response process,
generate a state representation based on the new state of the ePA request/response process, and
provide the state representation to the at least one storage component for storage thereby.

9. The system of claim 8, wherein the state modeling component further comprises:
an audit component configured to:
enter one or more discrete steps of the ePA request/response process into an audit table that is stored in the storage component based on at least one message received from an ePA provider system or an ePA requestor system;
determine completion of a step of the one or more discrete steps based on a subsequent message received from the ePA provider system or the ePA requestor system; and
query the storage component for information related to the one or more state representations of the ePA request/response process.

10. The system of claim 8, wherein the ePA request/response process is in accordance with an with a National Council for Prescription Drug Programs (NCPDP) standard,
wherein the framework is a resource description framework (RDF), and
wherein the framework model is an RDF model.

11. The system of claim 8, wherein the system further comprises:
a user interface (UI) service component;
wherein the audit component is configured to:
provide the information to the UI service component; and
wherein the UI service component is configured to:
generate a message that includes the information, the message being formatted such that the information may be utilized by a UI generation component on a computer of an ePA requestor system, and
provide the message to the UI generation component.

12. The system of claim 8, wherein the ePA request/response process includes one or more electronic communications between an ePA provider system and an ePA requestor system, and
wherein the information comprises an up-to-date history of the ePA request/response process.

13. A method performed by one or more servers for facilitating the delivery of at least one electronic prior authorization (ePA) by an ePA provider system to an ePA requestor system, the method comprising:
providing computer-executable instructions to a client computer of the ePA requestor system over a network, the instructions, when executed at the client computer, performing a client-side method comprising: dynamically generating a user interface (UI) based on at least a portion of a representation of a first XML message relating to at least one ePA request from the ePA requestor system that is received over the network;
receiving the first XML message from the ePA provider system over the network, the first XML message relating to the at least one ePA request from the ePA requestor system;
dynamically generating the representation;
providing the representation to the client computer;
generating, subsequent to providing the representation, a second XML message based on information received from the client computer, the information being obtained at the client computer via the UI; and
transmitting the second XML message to the ePA provider system over the network.

14. The method of claim 13, wherein the client-side method further comprises:
receiving the representation over the network;
presenting the UI to a user of the client computer;
dynamically generating a user input message that includes at least a portion of the information obtained by the client computer via the UI; and
transmitting the user input message to the one or more servers over the network.

15. The method of claim 13, wherein dynamically generating the UI in the client-side method comprises:
dynamically generating a first portion of the UI based on a first portion of the representation;
presenting the first portion of the UI to a user of the client computer;
dynamically generating a second portion of the UI based on a second portion of the representation and at least a portion of the information obtained by the client computer via the UI, and
presenting the second portion of the UI to the user of the client computer.

16. The method of claim 13, wherein the first and second XML messages are in accordance with a National Council for Prescription Drug Programs (NCPDP) message standard.

17. The method of claim 13, wherein the client-side method further comprises:
dynamically generating an additional UI based on at least a portion of an additional representation of a third XML message relating to an additional ePA request of the at least one ePA request from the ePA requestor system that is received over the network; and
the method further comprising:
receiving over the network the third XML message;
dynamically generating the additional representation;
providing the additional representation to the client computer,
generating, subsequent to providing the additional representation, a fourth XML message based on additional information received from the client computer, the additional information being obtained by the client computer via the UI; and
transmitting the fourth XML message to the ePA provider system over the network.

18. The method of claim 17, wherein dynamically generating the additional UI in the client-side method comprises:
dynamically generating a first portion of the additional UI based on a first portion of the additional representation;
presenting the first portion of the additional UI to a user of the client computer;
dynamically generating a second portion of the additional UI based on a second portion of the additional representation and at least a portion of the additional information obtained by the client computer via the UI, and
presenting the second portion of the additional UI to the user of the client computer.

19. The method of claim 18, further comprising:
tracking at least one current state of at least one process associated with one or more of the at least one ePA request respectively;
identifying respective changes from the at least one current state to at least one new state;
generating respective state representations based on the at least one new state; and
storing the respective state representations in a storage component of the one or more servers.

20. The method of claim 19, wherein tracking the at least one current state is based on a resource description framework (RDF) associated with the at least one ePA.
